(19) United States
(12) Patent Application Publication
(10) Pub. No.: US 2003/0126093 A1
(43) Pub. Date: Jul. 3, 2003

(54) Method and system for processing business

(76) Inventors: Toru Kuwahara, Yokohama (JP); Akira Saito, Saitama (JP); Tanjo Wakimoto, Chiba (JP); Kazuya Tamura, Tokyo (JP); Hajime Hirano, Asaka (JP); Ken Kutaragi, Kawasaki (JP)

Correspondence Address: Frommer Lawrence & Haug LLP, 745 Fifth Avenue, New York, NY, 10151, US

(21) Appl. No.: 09/764,475

(22) Filed: Jan. 17, 2001

(30) Foreign Application Priority Data
Jan. 17, 2000 (JP) 2000-8405

(51) Int. Cl. G06F 17/60

(52) U.S. Cl. 705/75

(57) ABSTRACT

To provide a business processing technical art which can carry out an order reception with a shortened waiting time of a customer, when carrying out an business through a network, an order reception processing section (122) carries out processing for receiving an on-line input of order information on specified business from an orderer, and processing for obtaining payment certifying information for certifying payment for the order. Further, an authorization request processing section (123) carries out an authorization request about payment certifying information through a payment center. At this time, the order reception processing section (122) supplies the orderer an on-line output of information indicating that the order has been received without waiting for presentation of a result of the authorization.

This application claims a priority based on Japanese Patent Application No. 2000-8405 filed on Jan. 17, 2000, the entire contents of which are incorporated herein by reference for all purposes.

### BACKGROUND OF THE INVENTION

The present invention relates to a method of processing business and a system of processing business in which business is conducted through a computer network, particularly to a method of processing business and a system of processing business including a technical art for processing an authorization request for payment certifying information.

Recently business on purchasing goods or receiving services has been conducted through a computer network, in particular, the Internet. In such business, an order of an intending purchaser is placed on goods supplied by a credit card member store (distributor) through the Web site, and on-line payment for the goods can be made by using a credit card. The on-line payment is performed by, for example, a series of procedures S1 to S6 as described below.

S1) An intending purchaser, by using an input form on the Web page shown in FIG. 6, inputs a company name of the credit card to be used 1041, a credit card number 1042 and an expiration date 1043. Information such as the name of the purchaser is assumed to have been inputted already.

S2) The intending purchaser clicks an order button 105 to transmit the above data to a credit card member store.

S3) The credit card member store transmits data of the name of the intending purchaser, an amount of payment, the name of the credit card company, the credit card number, and expiration date to a payment relay center to carry out processing of requesting a credit authorization (authorization) of the intending purchaser.

S4) The payment relay center, receiving the authorization request, makes an inquiry about credit information to the credit card company corresponding to the transmitted credit card company name. The result of the inquired credit information is transmitted to the credit card member store.

S5) The credit card member store informs the intending purchaser with a display of whether the purchase is accepted or not.

S6) The intending purchaser recognizes on the Web page that the purchase is accepted or not.

### SUMMARY OF THE INVENTION

Here, the credit card member store is a goods seller which has made a contract with the credit card company to allow the purchaser to make payment for the goods by using the credit card. The payment relay center carries out relaying business between the credit card member store and the credit card company. It is a company that receives an inquiry about credit information (authorization request) from the credit card member store, makes an inquiry about the credit information at the corresponding credit card company, and transmits back the result of the inquiry to the credit card member store.

In a conventional method for on-line payment using a credit card, the intending purchaser has to wait after placing an order until a decision is made as to whether the purchase is accepted or not with the Web page opened on which the order is placed. Namely, on the Web page, after transmitting information of the purchaser itself at S2), the purchaser has to wait with a message requesting to keep waiting being displayed as shown in FIG. 10, for example, and the Web page kept opened until the information at S5) is displayed to be recognized at S6).

In this case, even when a communication line is not busy, it sometimes takes some tens of seconds until the display for recognition of purchase is made through a procedure of the credit information authorization. Moreover, when there occurs a rush of intending purchasers at the Web site, the credit information authorization procedures are left undone. This possibly forces the intending purchasers to wait several minutes after the intending purchaser transmits information about itself until the acknowledgement is made as to whether the purchase is accepted or not with a connection to the Internet being remained. In such a situation, there is a possibility that the intending purchaser withdraws the request for purchasing goods before the display is presented for the intending purchaser to recognize that the purchase is accepted or not. Such a situation is not so desirable for the credit card member store as to result in losing a chance for selling goods.

Accordingly, it is an object of the present invention to provide a technical art for processing business in which an order with a shortened waiting time of a customer has been realized when the business is conducted through a network.

In order to achieve the above object, the first aspect of the present invention is a method of processing for receiving an order on on-line business comprising the steps of:

carrying out processing for receiving an on-line input of order information on specified business from an orderer, and processing for obtaining payment certifying information for certifying payment for the order; and

after receiving the order information supplying the orderer with an on-line output of information indicating that the order has been received, without waiting for presentation of a result of an authorization about the payment certifying information.

In order to achieve the above object, the second aspect of the present invention is a system for processing business which receives an order on business through a network comprising:

order reception processing means for carrying out processing for receiving an on-line input of order information on specified business from an orderer carried out through the network, and processing for obtaining payment certifying information for certifying payment for the order; and

an authorization request processing means for carrying out processing for requesting an authorization about the payment certifying information,

the order reception processing means, on receiving the input of the order information, carrying out processing for transmitting information indicating that the order has been received to the orderer through the network, and the processing for transmitting being carried out separately from the processing for requesting the authorization.

As the third aspect of the present invention, there is provided a system for processing business which receives an order on business on a Web page comprising:

a first system carrying out processing for receiving; and

one or more second systems carrying out processing for requesting an authorization,

the first system comprising:

order reception processing means for carrying out processing for receiving an on-line input of order information on specified business carried out on the Web page, and processing for obtaining payment certifying information for certifying payment for the order; and

authorization request transmitting means for transmitting an authorization request to be processed to the one or more second systems, and

each of the one or more second systems comprising:

authorization request processing means for carrying out processing for requesting an authorization about the payment certifying information: and

authorization request receiving means for receiving the authorization request from the first system,

the order reception processing means, on receiving the input of the order information, carrying out processing for displaying on the Web page information indicating that the order has been received, and the processing for displaying being carried out separately from the processing for requesting the authorization.

As the fourth aspect of the present invention, there is provided a system for processing business which receives an order for purchasing goods on a Web page comprising:

a first system carrying out

order receiving processing in which there are carried out processing for receiving an on-line input of order information on specified business carried out on the Web page, and processing for obtaining payment certifying information for certifying payment for the order; and

processing for requesting an authorization about the payment certifying information; and

one or more second systems carrying out

processing for requesting an authorization which is not processed in the first system,

the first system, on receiving the input of the order information, carrying out processing for displaying on the Web page information indicating that the order has been received, and the processing for displaying being carried out separately from the processing for requesting the authorization.

As the fifth aspect of the present invention, there is provided a system for processing business which receives an order for purchasing goods on a Web page comprising:

a first system comprising:

order reception processing means for carrying out processing for receiving an on-line input of order information on specified business carried out on the Web page, and processing for obtaining payment certifying information for certifying payment for the order;

first authorization request processing means for carrying out processing for requesting an authorization about the payment certifying information; and

authorization request transmitting means for transmitting outside an authorization request for which the first authorization request processing section carries out no processing; and

one or more second systems each comprising:

authorization request receiving means for receiving the authorization request transmitted from the first system: and

second authorization request processing means for carrying out processing for requesting an authorization about the received payment certifying information,

the order reception processing means, on receiving the input of the order information, carrying out processing for displaying on the Web page information indicating that the order has been received. and the processing for displaying being carried out separately from the processing for requesting the authorization.

### BRIEF DESCRIPTION OF THE DRAWINGS

FIG. 1 is a block diagram showing a first embodiment of a system according to the present invention;

FIG. 2 is an illustration showing an example of a home page of Web provided on the Internet by the Web server system;

FIG. 3 is an illustration showing an example of a membership identification page of the Web page for inputting a membership number and a password;

FIG. 4 is an illustration showing an example of the Web page for displaying a group of dealt goods;

FIG. 5 is an illustration showing an example of the Web page displaying a list of goods designated to be purchased:

FIG. 6 is an illustration showing an example of the Web page displaying an order form;

FIG. 7 is an illustration showing an example of the Web page displaying completion of a purchase order reception;

FIG. 8 is a block diagram showing a second embodiment of a system according to the present invention; and

FIG. 9 is a block diagram showing a third embodiment of a system for processing business according to the present invention.

FIG. 10 is an illustration showing a Web page displayed while a credit authorization procedure is carried out:

### DESCRIPTION OF THE PREFERRED EMBODIMENTS

In the following, embodiments of the present invention will be explained in detail with reference to the drawings. In the embodiments, explanations are made with cases of receiving orders on business on the Web page taken as examples. Of course the present invention is not limited to the business on the Web page, but can be applied to other kinds of on-line business. In the embodiments, examples are taken as business of purchasing goods. However, the present invention is not limited to business of goods. For example, the present invention can be applied to a case of placing an order concerning business for receiving a service.

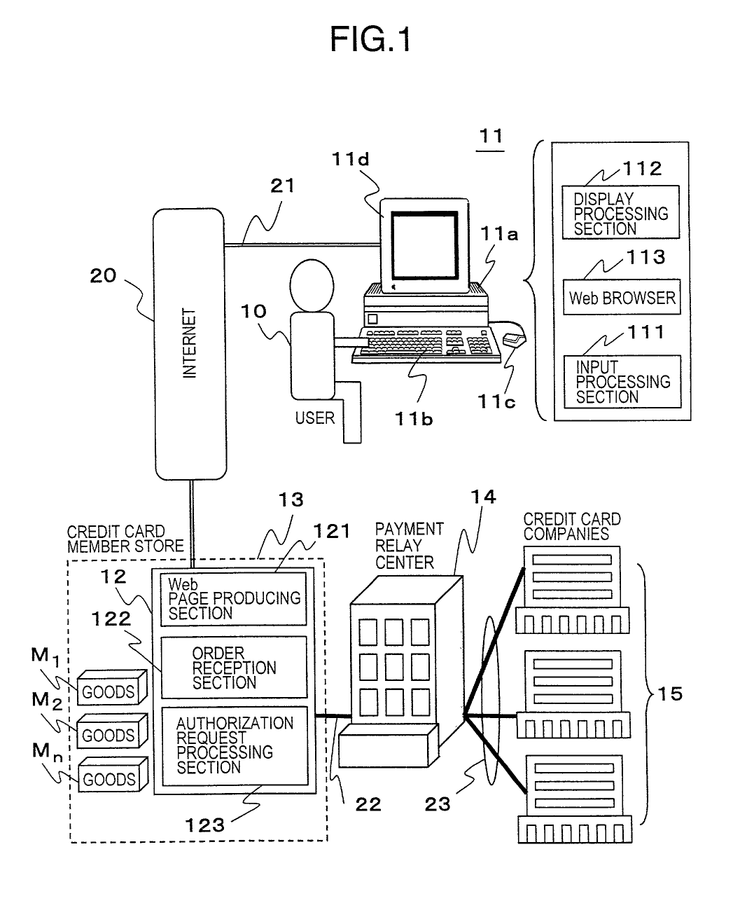

FIG. 1 is a schematic diagram showing an outline of a configuration of a network to which business processing system according to a first embodiment of the present invention is applied. The system shown in FIG. 1 is an example of a system in which on-line business is carried out by using the Internet 20. When carrying out business, payment certifying information for certifying payment for an order is obtained from a computer 11 of an orderer (user 10). Then, an authorization on the payment certifying information is requested to an organization conducting the authorization on the payment certifying information (a credit card company 15) through a payment relay center 14. This provides the fact whether the payment certificate information is valid, namely, credibility about the business included in the payment certifying information. In other words. it is insured that the payment is possible.

In this and the following embodiments, payment is to be performed by using a credit card and the organization for conducting the authorization is taken as a credit company that had issued the credit card to be used. As the payment certifying information, information for certifying payment with the credit card used is provided such as a user name, a credit card company name, a credit card number, an expiration date, an amount to be paid. Detailed example of the information will be explained later.

The way of payment according to the present invention is not limited to a credit card, but is applicable to other cases in which electronic business media are used for which authorizations of some kinds are necessary.

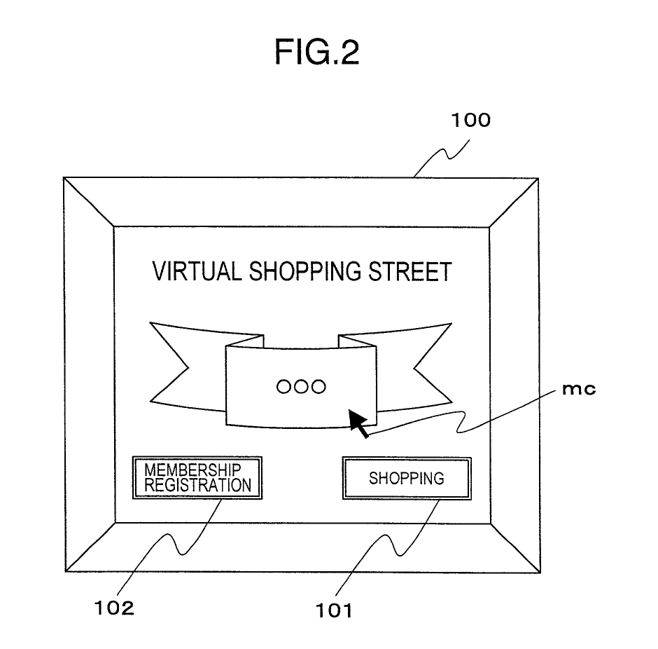

In FIG. 1, to the Internet 20, a plurality of computers 11 (only one of which is shown in FIG. 2) are connected through connection lines such as telephone lines 21. The user 10 utilizes the Internet by employing the computer 11. The computer 11 comprises a main body 11a, a keyboard 11b, a mouse 11c, and a display unit 11d. On the main body 11a, there are mounted various units, although not illustrated, such as a central processing unit (CPU, a main storage unit, an external storage unit. communication control unit. The external storage unit is constituted of. for example, a hard disk unit. The hard disk unit stores programs for making the CPU realize functions of an input processing section 111, a display processing section 112, and a Web browser 113. The function of the input processing section 111 is for processing inputs from the keyboard lib and the mouse 11c, and the function of the display processing section 112 is for controlling a display at the display unit 11d. The Web browser 113 functions as an interface for having access to a Web page of a server through the Internet 20.

Moreover, to the Internet 20, a Web server system 12 is connected. The Web server system 12 provides a setting for purchasing goods M1, M2, . . . Mn by the Web page. The Web server system 12 is specifically constituted by a computer. The Web server system 12 functions as a credit card member store 13 that allows payment with a credit card. It is not necessary for the goods M1, M2, . . . , Mn to be stocked at a location of the server, but is only necessary for them to be distributable after orders therefor are received.

In the computer of the Web server system 12, there are mounted various units, although not illustrated, such as a central processing unit (CPU), a main storage unit, an external storage unit, a communication control unit. The external storage unit is constituted of, for example, a hard disk unit. The hard disk unit stores programs for realizing various functions of sections such as a Web page producing section 121, an order reception processing section 122, and an authorization request processing section 123. The Web page producing section 121 is for producing the Web page, and the order reception processing section 122 functions as means for carrying out processing for receiving an order placed through the Web page. The authorization request processing section 123 functions as means for carrying out processing for requesting an authorization about the payment certifying information. The above programs are executed by the CPU to realize respective functions of the programmed sections.

The order reception processing section 122 carries out processing for receiving an on-line input of order information on specified business, and processing for obtaining the payment certifying information for certifying payment for the order. Moreover, the order reception processing section 122, on receiving the input of the order information, carries out processing for displaying information indicating that the order has been received. The information is displayed on the Web page through the Web page producing section 121. The processing for displaying is carried out separately from the processing for requesting the authorization. This can separate the order reception processing from the authorization request processing. Thus, the order reception can be completed without waiting for the display of the result of the authorization. Therefore, for the user 10 who placed an order by having access to the Web page, the waiting time until the completion of the order reception can be shortened.

The Web server system 12 is connected to the payment relay center 14 by a transmission line such as a public network or a special purpose line. The authorization request processing section 123 carries out processing for transmitting the payment certifying information to the predetermined payment relay center 14 as the processing for requesting an authorization.

Next, an explanation will be made as to how the business processing is carried out in the embodiment.

The Web server system 12 produces a Web page by means of the Web page producing section 121. On the Web page, there are displayed virtual stores to which orders can be placed. While, in the computer 11 used by the user 10, by starting the Web browser 113, it becomes possible for the user 10 to have access to the Web page produced by the Web server system 12 through the Internet 21.

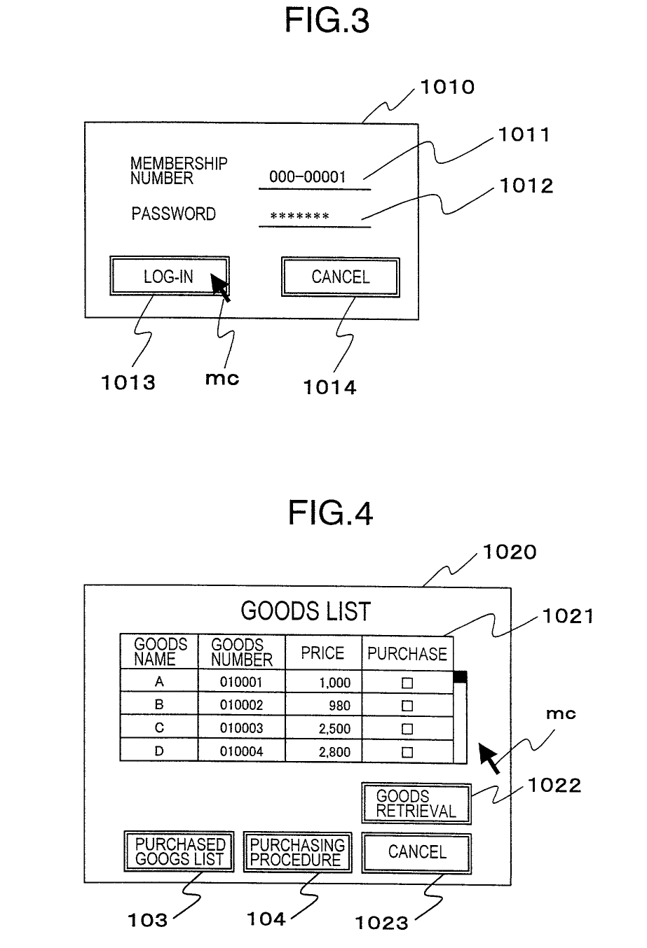

The Web page producing section 121 produces a home page 100 representing, for example, a virtual shopping street as shown in FIG. 2 and Web pages 1010 to 1050 in FIG. 3 to FIG. 7, respectively, each being shown as an example. In the home page 100 shown in FIG. 2, there are disposed a shopping button 101 and a membership registration button 102, which are for shifting the page to a membership identification page and a membership registration page, respectively.

A page shown in FIG. 3 is an example of the membership identification page 1010 for inputting a membership number and a password. On the page 1010, there are disposed a membership number space 1011 for inputting the membership number, a password space 1012 for inputting the password, a log-in button 1013, and a cancel button 1014.

A page shown in FIG. 4 is an example of a goods list page 1020 for displaying a group of dealt goods. On the page 1020, there are displayed a goods list 1021, a goods retrieval button 1022, a purchased goods list button 103, a purchasing procedure button 104, and a cancel button 1023. The purchased goods list button 103 and the purchasing procedure button 104 are for shifting the page to a purchased goods list page and a purchasing procedure page, respectively.

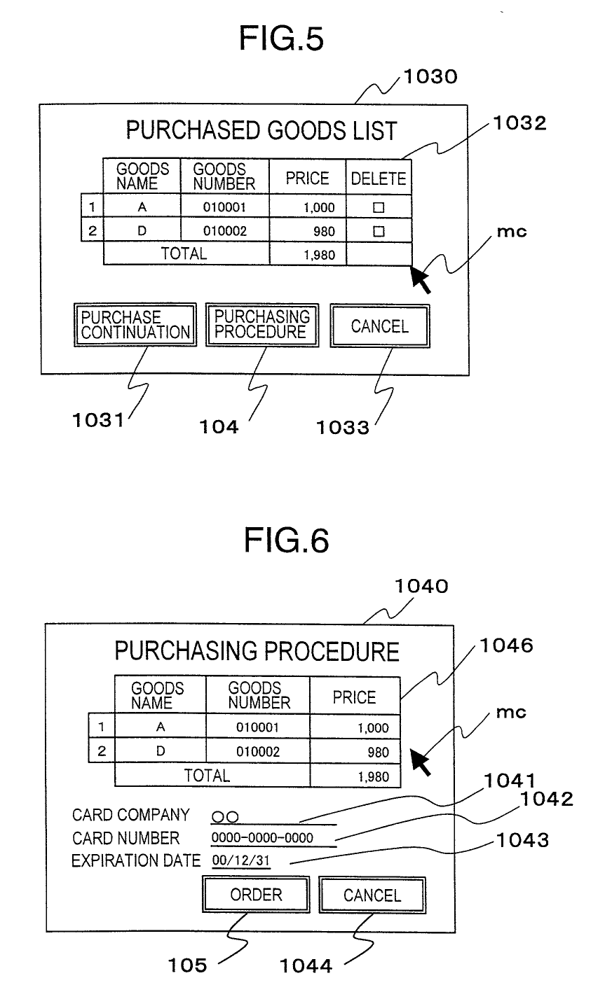

A page shown in FIG. 5 is an example of a purchased goods list page 1030 for displaying a list of goods designated to be purchased. On the page 1030, there are disposed a purchase continuation button 1031, a purchased goods list 1032, a purchase procedure button 104, and a cancel button 1033. The purchase continuation button 1031 is for inputting that the purchase of goods is continued, the purchased goods list 1032 is a list showing goods designated to be purchased, and the purchase procedure button 104 is for shifting the page to a purchase procedure page (order form page).

A page shown in FIG. 6 is an example of an order form page 1040 for displaying an order form. On the page 1040. there are disposed a purchased goods list 1046, a credit card company name space 1041, a credit card number space 1042, an expiration date space 1043, an order button 105, and a cancel button 1044. The purchased goods list 1046 shows a list of goods to be purchased. The credit card company name space 1041, the credit card number space 1042, and the expiration date space 1043 are spaces for inputting a credit card company name, a credit card number, and an expiration date of the card, respectively. The order button 105 is for placing an order.

The payment certifying information necessitated in the above described authorization request includes in the embodiment the credit card company name, the credit card number, and the expiration date inputted in the order form page 1040 shown in FIG. 6. In addition to this, the information also includes a total amount of price displayed in a total box 1047 in the purchased goods list 1046 in the same order form page.

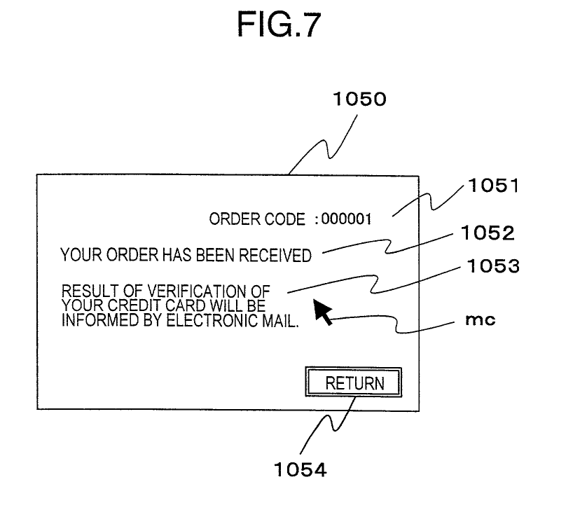

A page shown in FIG. 7 is an example of a reception completion page 1050 displaying completion of a purchase order reception. On the page 1050. there are disposed an order code field 1051, a reception message field 1052, a guide message field 1053, and a return button 1054. In the order code field 1051, an order code is displayed for identifying the received order. In the reception message field 1052, there is displayed a message reporting that the order is received, for example, a message “YOUR ORDER HAS BEEN RECEIVED”. In the information message field 1053, there is displayed an information message about verification of the result of the order reception, for example, a message “RESULT OF VERIFICATION OF YOUR CREDIT CARD WILL BE INFORMED BY ELECTRONIC MAIL”. The return button 1054 is for accepting an instruction to return.

The buttons displayed on each page can be selected by clicking. For example, a click about the order button 105 in the order form page 1040 shown in FIG. 6 makes the order reception processing section 122 carry out processing for receiving an order, that is, completing reception of input of order information. This makes the reception completion page 1050 shown in FIG. 7 displayed.

While, the Web server system 12 receives the order information from the user 10 and extracts payment certifying information. The system 12 then transmits the extracted information to the payment relay center 14 together with an authorization request about the information by a transmission line 22 such as a public network or a special purpose line, that is, carries out an inquiry about an authorization of the credit information.

The payment relay center 14 is connected to each of the credit card companies 15 by a transmission line 23 and transmits the authorization request about the payment certifying information to a company corresponding to the credit card used, that is, carries out inquiry about the credit information.

The credit card member store 13 can impose an obligation of membership registration on an intending user of the credit card beforehand. At the registration, prior to placing an order, the intending user transmits the credit card member store 13 private information of the intending user such as name, address, telephone number, date of birth, and electronic male address. The credit card member store 13 that received the private information issues a membership number and a password to the intending user. In addition to the private information, it is also possible to have information registered beforehand which is necessary for the payment with the credit card used by the intending user.

It is also possible for the credit card member store 13 to receive an order of goods without membership registration of the intending user. In this case, the private information of the intending user is transmitted every time the intending user places an order of goods. Furthermore, it is possible to impose a specified limitation to a service available for a nonmember.

The membership registration can be treated at the discretion of the credit card member store 13. In the embodiment, it is assumed that the credit card member store 13 imposes membership registration upon a user and the user 10 has made the membership registration beforehand.

With such a situation, an explanation will be made about a case in which the user 10 places an order for goods of the credit card member store 13.

The Web server 12 of the credit card member store 13 provides the home page 100 of the Web as shown in FIG. 2 on the Internet. Thus, the user 10 makes access to the Web server 12 by using a browsing software such as the Web browser 113 and browse the home page 100 by the Web browser 113. While browsing the home page 100, with the mouse pointer mc positioned on the shopping button 101, the user 10 can click the mouse 11c. On receiving an input provided by the click, the computer 11 makes, for member identification, the membership identification page 1010 as shown in FIG. 3 displayed on the display unit 11d for urging the user to input the membership number and password.

The membership number and the password inputted by the user 10 with the key bord 11b to the membership number space 1010 and the password space 1012, respectively, are received, an authentication of the membership is carried out. After the authentication, it becomes possible for the user to browse a group of goods displayed in the goods list 1021 of the virtual store on the goods list page 1020 as shown in FIG. 4. It is also possible for the user to retrieve desired goods by clicking the goods retrieval button 1022.

For any goods which the user 10 desires to purchase, the user 10 designates the goods number by using an inputting device such as the mouse 11c. It is also possible to designate a plurality of goods for purchase. The user 10 can check the designated goods list 1032 as necessary on the purchased goods list page 1030 as shown in FIG. 6.

The user 10 having finished designating desired goods is brought into a situation of inputting necessary information for credit card payment to the order form in the order form page 1040 as shown in FIG. 6 with the keyboard 11b. The kinds of necessary information are the credit card company name 1041, credit card number 1042, and the expiration date of the credit card 1043.

The user 10 having inputted the above information is allowed to push the order button 105 by clicking the mouse 11c with the mouse pointer mc positioned on the order button 105. On the order button 105 being pushed by the clicking, the computer 11 accepts the input to transmit the inputted order information about the order to the Web server 12.

In the Web server 12, on receiving the order information, the order reception processing section 122 accepts the input of the order information necessary for the business to obtain the information. Namely, there is obtained information including the membership number of the user, purchased goods code, number of goods, total amount of payment, the company name of the credit card used, the credit card number, and the expiration date of the credit card. The order reception processing section 122 also carries out extraction from the above to obtain necessary information for the payment certifying information. Instead, all of the above information may be obtained as the payment certifying information.

The obtained payment certifying information is transmitted as the authorization request to the payment relay center 14 through the transmission line 22 by the authorization request processing section 123. The transmission can be carried out for each business. Alternatively, a specified amount of the business information can be accumulated before being transmitted in batches. The authorization request can be encrypted for security.

When information necessary for the credit card payment has been registered at the credit card member store 13 beforehand by the user 10, no credit card information is necessary for being included in the payment certifying information. In this case, at the credit card member store 13, the user 10 is checked against the registered credit card information with the membership number of the user 10 taken as a key.

The order reception processing section 122, on receiving the input of the order information, carries out processing for displaying on the Web page information indicating that the order has been received. The processing for displaying is carried out separately from the processing for requesting the authorization. This allows the order reception processing to be completed without waiting for the result of the authorization.

In the order form page 1040 shown in FIG. 6, on the order button 105 being clicked by the user 10, the order reception processing section 122 receives the order information as described before. Along with this, the information indicating the reception completion page 1050 as shown in FIG. 7 is displayed. Therefore, it becomes unnecessary for the user 10 to wait with the Web page which is provide by web server 12 on the internet kept opened until a response of whether the purchase is accepted or not is displayed. This allows the user 10 to shift the Web page to other ones to freely browse them. Moreover, it is also possible for the user 10 to cut the system off the transmission line or to turn off the computer.

In this way, in the embodiment, on receiving an order online, the system is to transmit information of order reception completion to the orderer without waiting for the result of the authorization. Therefore, in the embodiment, it can be avoided to cause such a situation as to make a customer wait for authorization. This allows the credit card member store 13 creating the Web server 12 to lessen loss of business chances.

In the next, an explanation will be made about a case in which the Web server system 12 of the credit card member store 13, received an order from the user 10, carries out the processing according to the present invention.

The Web server system 12 of the credit card member store 13 that received the purchase information displays an image of the page 1050 showing that an order is received as shown in FIG. 7. The order code 1051 is a code used when the user 10 inquires purchase information or cancels the purchase. The return button 1054 is a button for terminating the display of the image of the page.

In the above, it is explained that the order input, placed through the Web page produced by the Web page producing section 121, is processed by the order reception processing section 122.

In the Web server system 12, the order information is once stored in a storing unit in the server system. After this, the authorization request processing section 122 transmits the credit card information designated by the user 10 and an amount of payment to the payment relay center 14 through the transmission line 22 to request an authorization thereof. The credit card information includes the credit card company name, the credit card number, and the expiration date of the credit card.

A timing with which the Web server system 12 transmits the credit card information and the amount of payment to the payment relay center 11 is arbitrary to such an extent that excessive congestion is not caused at least in the transmission line 22 connecting the Web server system 12 and the payment relay center 14. For example, when the order information is transmitted to the Web server system 12 of the credit card member store 13 with a frequency one for-every a few seconds, the Web server system 12 is to transmit the credit card information and the amount of payment of the user 10 to the payment relay center 14 immediately after the reception thereof. When the order information is transmitted to the Web server system 12 of the credit card member store 13 in concentration, the credit card information and the amount of payment information are temporarily stored in the Web server system 12. Then, the items of the temporarily stored information are transmitted to the payment relay center 14 one by one at intervals of a few seconds. The transmission may be carried out in late-night or early-morning hours in which the transmission line 22 is not relatively busy. The timing is taken as being set beforehand. Further, the timing may be set so that it is varied in compliance with the condition of reception of the order information.

The payment relay center 14, which received the credit card information and payment certifying information including the amount of payment from the web server system 12 of the credit card member store 13, requests an authorization about the business with the user 10 from the credit card company 15 corresponding to the company name of the credit card used.

The response from the credit card company 15 is taken as being classified into, for example, three types, i.e. 1) “USABLE”, 2) “UNUSABLE”, and 3) “EXCEEDS CEILING, APPROVAL IS NECESSARY”. Here, the response 3) “EXCEEDS CEILING, APPROVAL IS NECESSARY” is given when the amount of payment or cumulative amount of payment exceeds the amount of ceiling of the user 10 set beforehand, but the credit card becomes usable with the approval of the user 10.

The payment relay center 14 that received the response from the credit card company 15 transmits the response to the Web server system 12 of the credit card member store 13 through the transmission line 22 as the result of the authorization.

The Web server system 12 of the credit card member store 13 that received the result of the authorization from the payment relay center 14 transmits the user 10 an electronic mail with content corresponding to the result of the authorization. Namely, for the result of the authorization represented as “USABLE”, a so-called “Thanks mail” is transmitted which represents acknowledgement of conclusion of the sales contract and appreciation for the purchase. While, for the result of the authorization represented as “UNUSABLE”, an electronic mail is transmitted which represents that no credit of the card was obtained to result in no conclusion of sales contract.

With the result of the authorization represented as “EXCEEDS CEILING, APPROVAL IS NECESSARY”, the credit card member store 13 obtains approval of the credit card company 15 by making contact therewith by another contacting means such as a telephone or a mail. For the approval obtained as “USABLE”, an electronic mail is transmitted to the user 10 which mail represents acknowledgement of conclusion of the sales contract and appreciation therefor. While, when no approval is obtained as “UNUSABLE”, an electronic mail is transmitted which includes acknowledgement of no conclusion of sales contract and a message for urging reorder after the matter of the amount of the ceiling is settled.

Each type of the above electronic mails is transmitted in a routine format of its own which can be automatically produced in correspondence with the result of the authorization. In business in a system of a conventional method for authorization, such a kind of response was impossible to be realized. Instead of the electronic mail, other communication means such as facsimile may be applied.

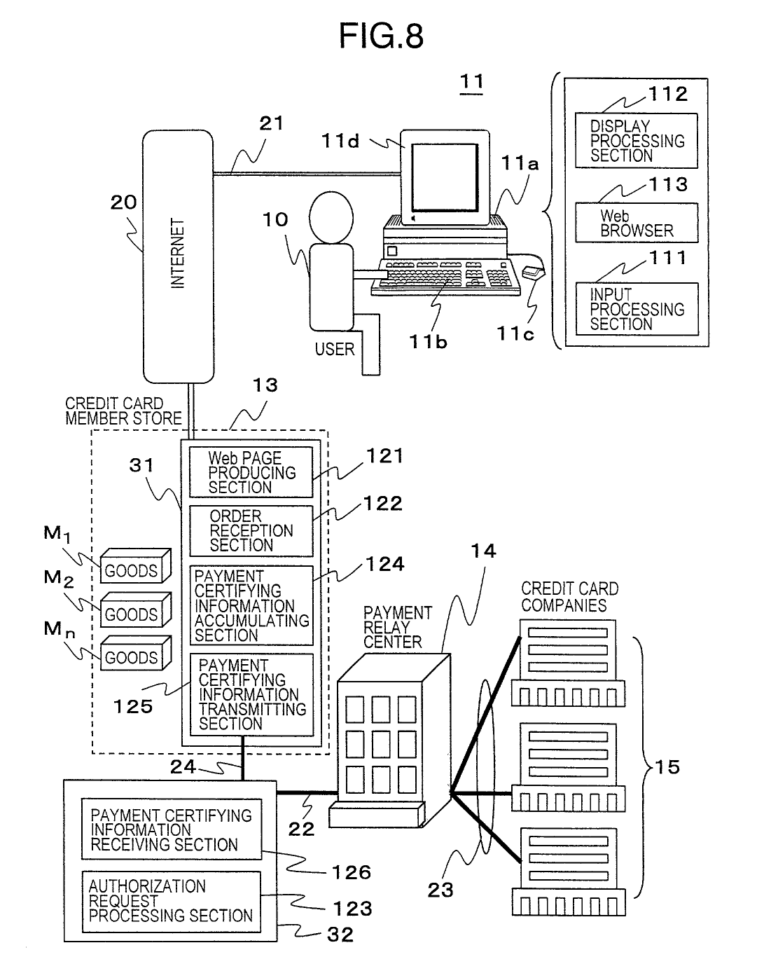

Next a second embodiment of the present invention will be explained next with reference to the drawing. As shown in FIG. 8, a system in the second embodiment is presented as an example which comprises a first system 31 carrying out processing for reception and a second system 32 carrying out processing for requesting an authorization. That is, the embodiment is an example in which the order reception processing and the authorization request processing are respectively carried out in separated hardware systems different from each other. The second embodiment, except for the point in which the system in the first embodiment is separated into two systems, is basically the same as the first embodiment. Therefore, the explanation will be made with a particular emphasis on the different points.

The first system 31 comprises a Web page producing section 121, an order reception processing section 122, a payment certifying information transmitting section 125, and a payment certifying information accumulating section 124. The order reception processing section 122 functions as means for carrying out processing for receiving an on-line input of order information on specified business on the Web page, and processing for obtaining the payment certifying information for certifying payment for the order. The payment certifying information transmitting section 125 functions as means for transmitting the payment certifying information to the second system 32. The payment certifying information accumulating section 124 temporarily accumulates the payment certifying information necessary for the authorization request.

The order reception processing section 122, like in the case of the first embodiment, on receiving the input of the order information, carries out processing for displaying on the Web page the information indicating that the order has been received. The order reception processing is carried out separately from the processing for requesting the authorization.

The second system 32 comprises a payment certifying information receiving section 126 and an authorization request processing section 123. The payment certifying information receiving section 126 functions as means for receiving the payment certifying information from the first system 31, and the authorization request processing section 123 functions as means for carrying out processing for requesting an authorization about the payment certifying information.

In this case of the second embodiment, as shown in FIG. 8, the second system 32 is provided between the Web server system of the credit card member store 13 (the first system 31) and the payment relay center 14. The second system 32 may belong to the credit card member store 13 and it may be provided as a separate constituent. The first system 31 and the second system 32 are connected through a transmission line 24 such as a public network or a special purpose line. The second system 32 and the payment relay center 14 are connected with the transmission line 22.

In the second embodiment, like in the first embodiment, the order reception processing section 122 obtains order information from the user 10. From the order information obtained, the payment certifying information is further obtained. In the embodiment, the obtained payment certifying information is temporarily accumulated in the payment certifying information accumulating section 124 and, when a specified amount of the information is accumulated, the information is transferred to the second system 32 by the payment certifying information transmitting section 125. Here, the payment certifying information transmitting section 125 transfers the payment certifying information and the amount of payment to the second system 32 by using, for example, FTP (File Transfer Protocol). The payment certifying information to be transferred includes credit card information comprising such items as the credit card company name, the credit card number, and the expiration date of the credit card. In the embodiment, the payment certifying information is transferred as an authorization request to the second system 32 by the payment certifying information transmitting section 125.

In the second system 32, the payment certifying information receiving section 126 receives the payment certifying information. On the basis of the received payment certifying information, the authorization request processing section 123 transmits the authorization request to the payment relay center 14 in a specified format through the transmission line 22. A timing, with which the second system 32 transmits the payment certifying information to the payment relay center 14, can be set as necessary.

According to the second embodiment, the same effect as that of the above first embodiment can be expected. In addition, by separating the processing for order reception and the processing for authorization request, hardware resources can properly share the load thereon. Moreover, it becomes possible to provide a plurality of the second systems 32 that carry out authorization request processing. This enables efficient authorization request processing. Furthermore, by dynamically allotting a plurality of the second systems to a plurality of the first systems. respectively, an efficient processing can be carried out in compliance with the utilization conditions of the first systems.

In both the second embodiment and a later described third embodiment, in transferring the authorization request from the first system to the second system, the payment certifying information is accumulated until the amount of the payment certifying information becomes a specified amount. However, the present invention is not limited to this, but the information can be transferred one by one for each reception of order.

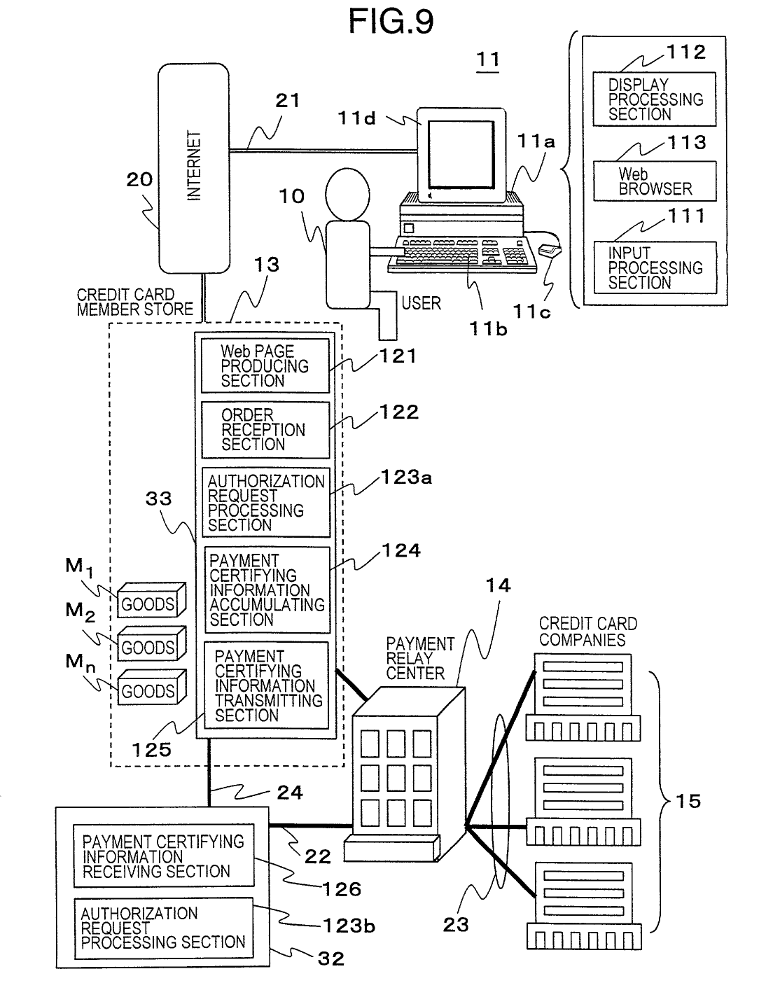

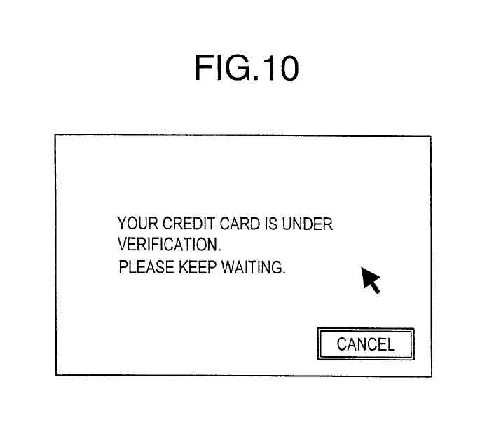

Next, the third embodiment of the present invention will be explained with reference to the drawing. As shown in FIG. 9, a system according to the third embodiment comprises a first system 33 and a second system 32 functioning as an auxiliary system of the first system 33. Here, explanation of the like constitution and functions of the constituents as those in the first and second embodiments is omitted and an explanation will be made only about different points.

The first system 33 comprises a Web page producing section 121, an order reception processing section 122, a first authorization request processing section 123a, a payment certifying information transmitting section 125, and a payment certifying information accumulating section 124. The order reception processing section 122 carries out processing for processing for receiving an on-line input of order information on specified business on the Web page, and processing for obtaining the payment certifying information for certifying payment for the order. The first authorization request processing section 123a functions as first means for carrying out processing for requesting an authorization about the payment certifying information. The payment certifying information transmitting section 125 functions as means for transmitting outside the payment certifying information necessary for the authorization request which is not processed by the first authorization request processing section 123a. The payment certifying information accumulating section 124 temporarily accumulates the payment certifying information necessary for the authorization request when the information is transmitted to the second system.

The second system 32 comprises a payment certifying information receiving section 126 and a second authorization request processing section 123b. The payment certifying information receiving section 126 receives the payment certifying information transmitted from the first system 33, and the second authorization request processing section 123 carries out processing for requesting authorization about the received payment certifying information.

In the third embodiment, the second system 32 is provided as being single. However, like in the second embodiment, two or more second systems 32 can be prepared.

The order reception processing section 122, like in the case of the first embodiment, on receiving the input of the order information, carries out processing for displaying on the Web page the information indicating that the order has been received. The order reception processing is carried out separately from the processing for requesting the authorization.

In the third embodiment, the second system 32 operates when an amount of the authorization request processing exceeds a processing capacity of the first system 33. For example, when a situation is caused in which an amount of the payment certifying information exceeds a specified amount in the payment certifying information accumulating section 124, the accumulated payment certifying information is transferred to the second system 32. Alternatively, the payment certifying information is transferred to the second system 32 by an amount exceeded the specified one.

The authorization requests in the first and second systems 33 and 32 are basically the same as those explained in the first and second embodiments.

About the third embodiment, the same effect can be also expected as those of the above first and second embodiments.

In the above-described third embodiment, a configuration is presented which makes the second system 32 function as an auxiliary system of the first system 33. However, the present invention is not limited to this. For example, the first and the second system can be made to share the authorization request processing. In this case, the payment certifying information accumulating section 124 is made to function as a buffer for carrying out the transfer of the payment certifying information in batch processing. Of course, the transfer of the information from the first system 33 to the second system 32 can be carried out by serial processing rather than the batch processing. Further. instead of the payment certifying information accumulating section 124, a sharing decision section (not shown) may be provided for deciding shares of the authorization request processing carried out by the respective first and second systems.

As described above, according to the present invention, in carrying out business through a network, an order reception can be carried out with a shortened waiting time for a customer.

What is claimed is:

1. A method of processing a reception of an order on-line business comprising the steps of:
carrying out processing for receiving an on-line input of order information on specified business from an orderer and processing for obtaining payment certifying information for certifying payment for the order; and
after receiving the order information, supplying the orderer on on-line output of information indicating that the order has been received, before a result of authorization about the payment certifying information is presented.

2. A method of processing a reception of an order on on-line business as claimed in claim 1 wherein
the payment certifying information is information for certifying that the payment is made using a credit card.

3. A method of processing a reception of an order on on-line business comprising the steps of:
carrying out processing for receiving an on-line input of order information on specified business from an orderer, and processing for obtaining payment certifying information for certifying payment for the order;
after receiving the order information, supplying the orderer an on-line output of information indicating that the order has been received; and
after receiving the order information, carrying out processing for requesting authorization about the payment certifying information.

4. A method of processing a reception of an order on on-line business as claimed in claim 3 wherein
the payment certifying information is information for certifying that the payment is made using a credit card.

5. A system for processing business which receives an order on business through a network comprising:
order reception processing means for carrying out processing for receiving an on-line input of order information on specified business from an orderer carried out through the network, and processing for obtaining payment certifying information for certifying payment for the order; and
authorization request processing means for carrying out processing for requesting authorization about the payment certifying information,
the order reception processing means, on receiving the input of the order information, carrying out processing for transmitting information indicating that the order has been received to the orderer through the network, and the processing for requesting the authorization.

6. A system for processing business as claimed in claim 5 wherein
the order reception processing means and the authorization request processing means comprise hardware systems different from each other, the order reception processing means comprising a first system, and the authorization request processing means comprising a second system,
the first system comprising means for transmitting the payment certifying information to the second means, and
the second system comprising means for receiving the payment certifying information from the first system.

7. A system for processing business as claimed in claim 5 wherein the authorization request processing means carries out processing, as the processing for requesting the authorization, for transmitting the payment certifying information to a payment relay center specified beforehand.

8. A system for processing business a claimed in claim 5 wherein the payment certifying information is information for certifying the payment using a credit card.

9. A system for processing business as claimed in claim 5 wherein the order reception processing means receives the order of purchasing goods as business.

10. A system for processing business as claimed in claim 6 wherein
a plurality of the second systems are disposed,
the first system further comprises means for selecting the second system being to transmit the payment certifying information , and
the means for selecting the second system selects on second system from the plurality of the second systems.

11. A system for processing business as claimed in claim 6 wherein
the first system further comprises means for accumulating a specified amount of the payment certifying information and thereafter transmitting the accumulated information to the second system in batches.

12. A system for processing business which receives an order on business on a Web page comprising:
order reception processing means for carrying out processing for receiving an on-line input of order information on specified business carried out on the Web page, and processing for obtaining payment certifying information for certifying payment for the order; and
authorization request processing means for carrying out processing for requesting authorization about the payment certifying information,
the order reception processing means, on receiving the input of the order information, carrying out processing for displaying on the Web page information indicating that the order has been received, and the processing for displaying being carried out separately from the processing for requesting the authorization.

13. A system for processing business as claimed in claim 12 wherein
the order reception processing means and the authorization request processing means comprise hardware systems different from each other, the order reception processing means comprising a first system, and the authorization request processing means comprising a second system,
the first system comprising means for transmitting the payment certifying information to the second means, and
the second system comprising means for receiving the payment certifying information from the first system.

14. A system for processing business as claimed in claim 12 wherein the authorization request processing means carries out processing, as the processing for requesting the authorization, for transmitting the payment certifying information to a payment relay center specified beforehand.

15. A system for processing business a claimed in claim 12 wherein the payment certifying information is information for certifying the payment using a credit card.

16. A system for processing business as claimed in claim 12 wherein the order reception processing means receives the order of purchasing goods as business.

17. A system for processing business as claimed in claim 13 wherein
a plurality of the second systems are disposed,
the first system further comprises means for selecting the second system being to transmit the payment certifying information , and
the means for selecting the second system selects on second system from the plurality of the second systems.

18. A system for processing business as claimed in claim 13 wherein
the first system further comprises means for accumulating a specified amount of the payment certifying information and thereafter transmitting the accumulated information to the second system in batches.

19. A system for processing business which receives an order on business on a Web page comprising:
a first system carrying out processing for receiving; and
a second system carrying out processing for requesting authorization, the first system comprising:
authorization request processing means for carrying out processing for requesting an authorization about the payment certifying information: and
means for receiving the payment certifying information from the first system,
the order reception processing means, on receiving the input of the order information, carrying out processing for displaying on the Web page information indicating that the order has been received, and the processing for displaying being carried out separately from the processing for requesting the authorization.

20. A system for processing business as claimed in claim 19 wherein
a plurality of the second systems are disposed,
the first system further comprises means for selecting the second system being to transmit the payment certifying information, and
the means for selecting the second system selects on second system from the plurality of the second systems.

21. A system for processing business as claimed in claim 19 wherein
the first system further comprises means for accumulating a specified amount of the payment certifying information and thereafter transmitting the accumulated information to the second system in batches.

22. A system for processing business as claimed in claim 19 wherein the authorization request processing means carries out processing, as the processing for requesting the authorization, for transmitting the payment certifying information to a payment relay center specified beforehand.

23. A system for processing business a claimed in claim 4, 5, 7 10, 16 or 17 wherein
the payment certifying information is information for certifying the payment using a credit card.

24. A system for processing business as claimed in claim 4, 5, 7, 10, 16 or 17 wherein
the order reception processing means receives the order of purchasing goods as business.

25. A system for processing business which receives an order for purchasing business which receives an order for purchasing goods on a Web page comprising:
a first system comprising:
order reception processing means for carrying out processing for receiving an on-line input of order information on specified business carried out on the Web page, and processing for obtaining payment certifying information for certifying payment for the order;
first authorization request processing means for carrying out processing for requesting an authorization about the payment certifying information; and
payment certifying information transmitting means for transmitting outside payment certifying information corresponding to an authorization request for which the first authorization request processing means carries out not processing; and
one or more second systems each comprising:
payment certifying information receiving means for receiving the payment certifying information transmitted from the first system; and
second authorization request processing means for carrying out processing for requesting authorization about the received payment certifying information, the order reception processing means, on receiving the input of the order information, carrying out processing for displaying on the Web page information indicating that the order has been received, and the processing for displaying being carried out separately from the processing for requesting the authorization.

26. A system for processing business as claimed in claim 25 wherein
the first system and the one or more second systems are connected through communication lines, and
the first authorization request transmitting means in the first system transmits the payment certifying information to the second systems through the communication lines.

27. A system for processing business as claimed in claim 25 wherein the authorization request processing means carries out processing, as the processing for requesting the authorization, for transmitting the payment certifying information to a payment relay center specified beforehand.

28. A system for processing business a claimed in claim 25 wherein the payment certifying information is information for certifying the payment using a credit card.

29. A system for processing business as claimed in claim 25 wherein the order reception processing means receives the order of purchasing goods as business.

30. A system for processing business as claimed in claim 29 wherein the first authorization request processing means in the first system and the second authorization request processing means in the second system share the processing for requesting the authorization.

31. A system for processing business as claimed in claim 30 wherein the second authorization request processing means in the second system functions as an auxiliary system which is operated when an amount of the processing for requesting authorization exceeds a processing capacity of the first authorization request processing means in the first system.

32. A system for processing business as claimed in claim 30 wherein the first system further comprises means for accumulating a specified amount of the payment certifying information for which the request for authorization is necessary, and for transmitting thereafter the accumulated information to the second system in batches.

33. A system for processing business as claimed in claim 30 wherein the authorization request processing means carries out processing, as the processing for requesting the authorization, for transmitting the payment certifying information to a payment relay center specified beforehand.

34. A system for processing business as claimed in claim 31 wherein the first system further comprises means for accumulating a specified amount of the payment certifying information for which the request for authorization is necessary, and for transmitting thereafter the accumulated information to the second system in batches.

35. A system for processing business which receives an order for purchasing goods on a Web page comprising:
a first system carrying out
order receiving processing in which there are carried out processing for receiving an on-line input of order information on specified business carried out on the Web page, and processing for obtaining payment certifying information for certifying payment for the order; and
processing for requesting authorization about the payment certifying information; and
second system carrying out processing for requesting authorization which is not processed in the first system,
the first system, on receiving the input of the order information indicating that the order has been received, and the processing for displaying being carried out separately from the processing for requesting the authorization

36. A system for processing business a claimed in 35 wherein the payment certifying information is information for certifying the payment using a credit card.

37. A system for processing business as claimed in claim 35 wherein the order reception processing means receives the order of purchasing goods as business.

38. A system for processing business which receives an order for purchasing goods on a Web page comprising:
order reception processing means for carrying out processing for receiving on-line input of order information on specified business carried out on the Web page, and processing for obtaining payment certifying information for certifying payment for the order; and
authorization request transmission means for transmitting outside a request for authorization about the payment certifying information,
the order reception processing means, on receiving the input of the order information indicating that the order has been received, and the processing for displaying being carried out separately from the processing for requesting the authorization.

39. A system for processing business a claimed in claim 38 wherein the payment certifying information is information for certifying the payment using a credit card.

40. A system for processing business as claimed in claim 38 wherein
the order reception processing means receives the order of purchasing goods as business.
